(19) United States
(12) Patent Application Publication
(10) Pub. No.: US 2018/0169449 A1
(43) Pub. Date: Jun. 21, 2018

(54) FIRE SUPPRESSION DEVICE

(71) Applicant: David Graham MILLAR, Melbourne (AU)

(72) Inventor: David Graham MILLAR, Melbourne (AU)

(21) Appl. No.: 15/736,822

(22) PCT Filed: Jun. 15, 2016
(86) PCT No.: PCT/AU2016/050488

§ 371 Date: Dec. 15, 2017

(30) Foreign Application Priority Data
Jun. 16, 2015 (AU) 2015902283
Jul. 28, 2015 (AU) 2015902987

(51) Int. Cl. A62C 19/00

(52) U.S. Cl. CPC A62C 19/00

(57) ABSTRACT

Conventional fire extinguishers have limited use in a situation where a fire has become well established and where it is no longer possible to gain access to the seat of the blaze. The present invention solves this problem by providing a fire suppression device that is adapted to be thrown into a fire, and which will rupture to expel fire fighting agent over a useful area to help suppress the fire. The fire suppression device includes an ejection device and the device is configured such that it can spread fire fighting agent in its immediate vicinity as well as expel projectiles which can carry fire fighting agent a greater distance. This maximises the area of influence of the fire suppression device, and does not require the operator to enter the fire and expose themselves to danger.

### FIELD OF THE INVENTION

This invention relates to a fire suppression device, and in particular, but not exclusively to a fire suppression device for first responder use in the suppression of fires in civilian, maritime and military situations.

### BACKGROUND

Fire extinguishers are commonly used by first responders when an unwanted fire is found in a building, vehicle or other situation.

While currently available fire extinguishers are useful in suppressing a small fire, they are difficult to use if the fire has become established. That is because it is necessary for the person using the fire extinguisher to get relatively close to the seat of the blaze.

When a fire has become established, there is considerable heat being generated, and often smoke and/or toxic fumes. These hazards will generally keep a first responder from getting close to the seat of the fire. In addition, the seat of the fire may have become widespread making it increasingly difficult to direct the fire fighting agent to the entire area that is ablaze.

In such circumstances it is often necessary to be trained, and to have protective equipment, for example clothing that provides protection from the heat and breathing apparatus.

In addition, some environments include automated fire suppression systems that may displace oxygen from the environment. There is added to danger to an untrained or poorly equipped fire fighter who may attempt to enter such an environment to begin fighting a fire.

Therefore, since many first responders are untrained, and protective clothing and equipment is not readily available, the usefulness of currently available fire extinguishers is limited when a fire has become established or when a fire has started in a potentially hazardous area.

In this specification unless the contrary is expressly stated, where a document, act or item of knowledge is referred to or discussed, this reference or discussion is not an admission that the document, act or item of knowledge or any combination thereof was at the priority date, publicly available, known to the public, part of common general knowledge; or known to be relevant to an attempt to solve any problem with which this specification is concerned.

### OBJECT

It is therefore an object of the present invention to provide a fire suppression device which will at least go some way towards overcoming one or more of the above mentioned problems, or at least provide the public with a useful choice.

### STATEMENTS OF THE INVENTION

Accordingly, in a first aspect, the invention may broadly be said to consist in a fire suppression device having multiple compartments in which a fire fighting agent or agents are held, and having an ejection system adapted to activate the fire fighting agent held in at least some of the compartments and to disperse the fire fighting agent or agents into the space surrounding the fire suppression device.

Preferably at least some of the compartments are in the form of projectiles that are configured to be ejected from the fire suppression device by the ejection system when the ejection system is activated.

Preferably at least one of the compartments is in the form of a space surrounding the ejection system and defined within, an at least partially frangible, or rupturable, outer housing or skin.

Preferably the frangible, or rupturable, outer housing or skin includes a sleeve made of a rubberised product.

Preferably the frangible, or rupturable, outer housing includes lines of weakness configured to allow the outer housing to rupture or break in a pre-determined manner.

Preferably the ejection system includes an inner housing that is surrounded by the compartments in which an ignitable fire fighting agent is held.

Preferably the inner housing includes holes configured to support and retain the projectiles until the ejection system is activated.

Preferably the projectiles are held within the holes of the inner housing by an interference fit between the projectiles and the holes.

Optionally some or all of the projectiles are held within the holes of the inner housing by a threaded connection between the projectiles and the holes.

Optionally some of the compartments are in the form of housings fixed to the inner housing and configured to release fire fighting agent in the immediate vicinity of the fire suppression device.

Preferably the ejection system includes a bursting charge.

Preferably the bursting charge includes a flammable compound.

Optionally the bursting charge includes an explosive compound.

Optionally the bursting charge includes a compressed material.

Preferably the compressed material is a compressed inert gas.

Preferably the ejection system includes a time delayed triggering system.

Preferably the activation of the fire fighting agent is by ignition.

Preferably the projectiles are in the form of cylindrical casings which hold a quantity of ignitable fire fighting agent, and which are open at one end to the bursting charge of the ejection system and configured so that the ignition of the fire fighting agent in each projectile occurs substantially simultaneously.

Preferably each of the cylindrical casings includes an orifice that is initially in communication with the bursting charge of the ejection system, and each orifice is configured to produce a high velocity flow of fire fighting agent combustion products from the interior of each of the casings when the casings are ejected by the ejection system.

Preferably the space surrounding the projectiles and the ejection system and within the outer housing or skin is filled with fire fighting agent.

Preferably, the fire fighting agent is a compound or mixture that is activated by ignition.

Preferably the fire fighting agent surrounding the projectiles is a monoammonium phosphate based product.

Preferably the fire fighting agent contained within each of the projectiles is of a type that uses a potassium nitrate based reaction.

Preferably the time delayed triggering system includes a sprung firing pin, a detonating cap and an incendiary delay fuse or other suitable ignition delay system.

Preferably the outer housing includes at least one hard edge configured for use in breaking hard objects such as glass panels.

In a second aspect, the invention may broadly be said to consist in a fire suppression device having a plurality of individual containers configured to hold and to disperse a fire fighting agent, and having an ejection system configured to propel some or all of the containers from the device and to the area surrounding the device, and a triggering system configured to initiate the ejection system.

Preferably the triggering system includes a time delay feature configured to allow the fire suppression device to first be triggered and then to be thrown into or toward a fire.

Preferably the triggering system includes a manually operated lever.

Preferably the ejection system includes a bursting charge configured to propel each of the containers from the device.

Preferably the bursting charge includes a flammable compound.

Optionally the bursting charge includes an explosive compound.

Optionally the bursting charge includes a compressed material.

Preferably the compressed material is an inert gas.

Preferably each of the containers is supported by a central body portion of the fire suppression device prior to being ejected from the device.

Preferably the containers are open to the ejection system.

Preferably the fire fighting agent is of the type that burns to produce a fire suppressant product.

Preferably the fire fighting agent is ignited by the bursting charge when the containers are propelled from the device.

Preferably the fire fighting agent is of the type that uses a potassium nitrate reaction.

Preferably the device includes a frangible or rupturable outer casing.

Preferably the rupturable outer casing includes a sleeve made of a rubberised product.

Preferably the rupturable outer casing includes lines of weakness configured to allow the outer casing to rupture in a pre-determined manner.

Preferably the central body of the device includes a tubular member which houses the ejection system.

Preferably the tubular member includes holes which are configured to hold and support the containers prior to the containers being propelled from the device.

Preferably the rupturable outer casing is configured to assist in supporting and retaining the containers prior to the containers being propelled from the device.

Preferably any space within the rupturable outer casing and between each of the containers is filled with a fire fighting agent.

Preferably the fire suppression device includes a handle configured to facilitate handling of the device.

Preferably the manually operated lever of the triggering system is located adjacent to the handle.

Preferably the manually operated lever can be held against the handle, when a locking mechanism is released, to delay or prevent triggering of the triggering system.

Preferably the triggering system includes a slow burning fuse.

Optionally, a short length of burning fuse may be used to bridge the gap between the propulsion media, through the orifice of the projectile into the potassium fire fighting agent to ensure greater reliability. This arrangement may be adapted to create a rapid but not explosive outer casing burst.

Optionally the triggering system includes a mechanism configured to trigger the device when the device comes into contact with another object or a surface.

The invention may also broadly be said to consist in the parts, elements and features referred to or indicated in the specification of the application, individually or collectively, and any or all combinations of any two or more of the parts, elements or features, and where specific integers are mentioned herein which have known equivalents, such equivalents are incorporated herein as if they were individually set forth.

### DESCRIPTION

Further aspects of the present invention will become apparent from the following description which is given by way of example only and with reference to the accompanying drawings in which:

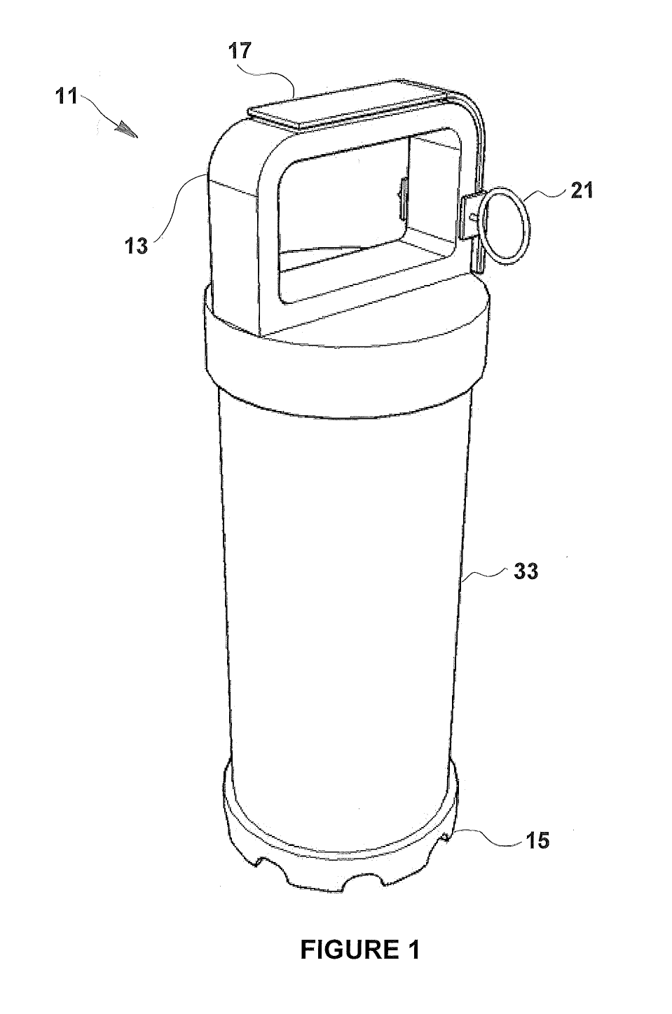

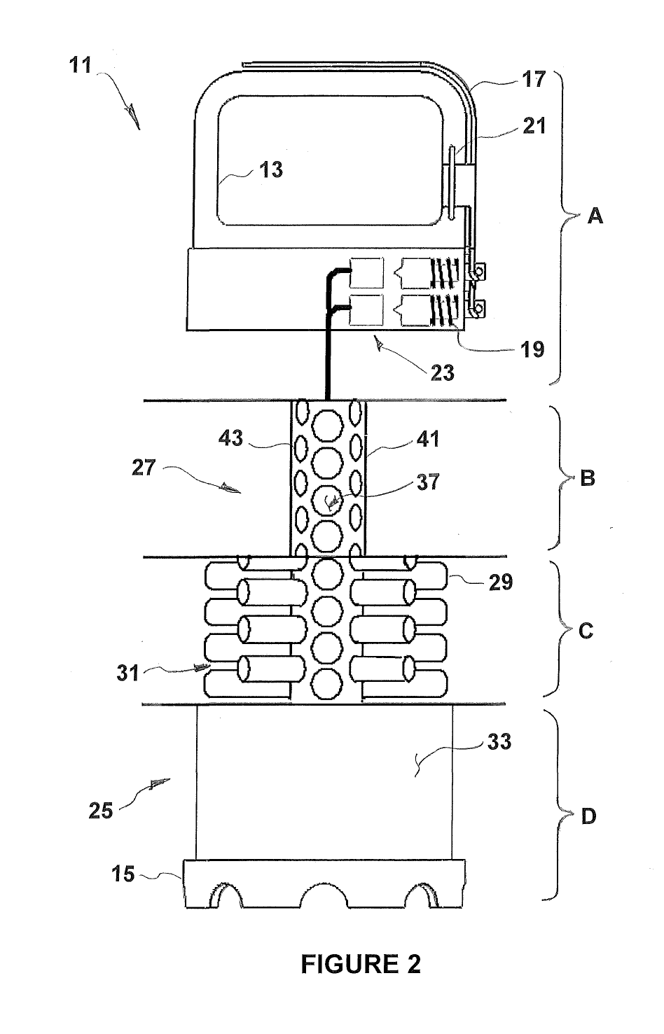

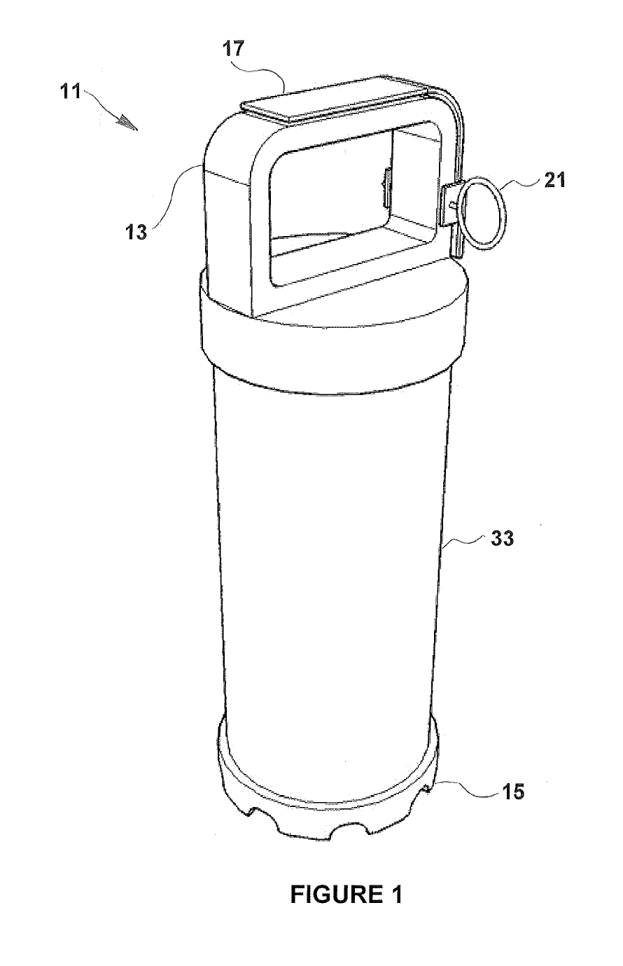

FIG. 1 is a perspective view of a fire suppression device,

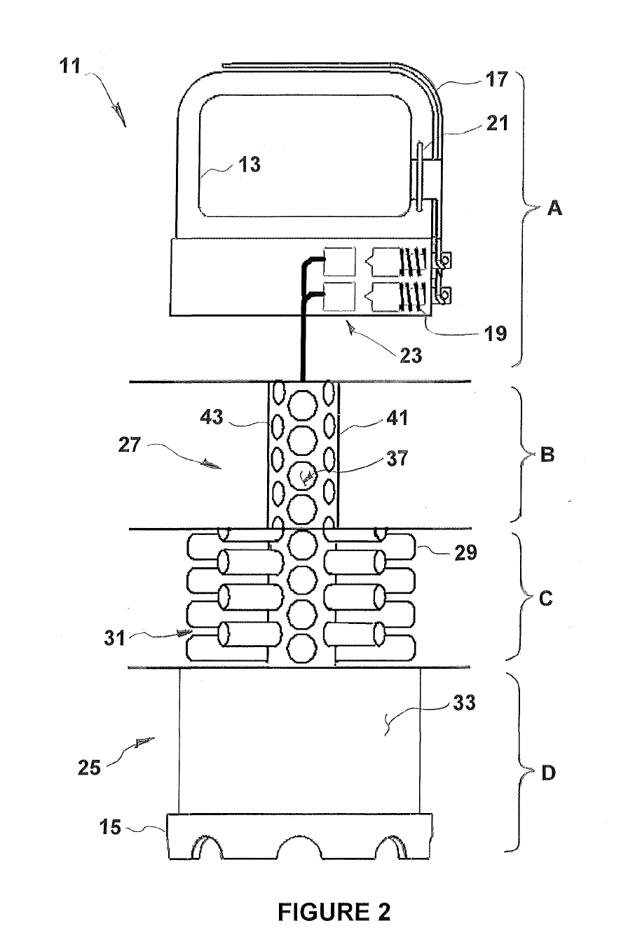

FIG. 2 is a sectioned cutaway side elevation view showing internal components of the fire suppression device.

With reference to FIGS. 1 and 2, a fire suppression device (11) according to the present invention will now be described. The fire suppression device (11) is configured such that it can be thrown right into the seat of a fire, and it is designed to disperse fire fighting agent, including fire fighting agent that is held within separate containers, about an area that is ablaze.

The fire suppression device (11) includes a handle (13) at a top end, and a hard crenulated ring (15) that forms a base of the device. The hard crenulated base ring (15) has hard edges that are intended to assist in breaking through barriers such as glass panels to assist in getting the fire suppression device (11) to the seat of a fire.

A manually operated trigger (17) is situated on the handle (13). The trigger (17) is biased toward a firing position by a spring (19), but is held in a safety mode by a pin (21). When the pin (21) is removed, the trigger (17) can be held in the safety mode by the hand holding the handle (13), and then when the device (11) is thrown, the trigger (17) will extend under the action of the spring (19), and a time delayed triggering system (23) will be initiated.

The fire suppression device (11) has multiple compartments in which a fire fighting agent, or a number of fire fighting agents, are held. The compartments are all housed within an outer housing or skin (25).

The time delayed triggering system (23) is configured to trigger an ejection system (27) adapted to ignite the fire fighting agent in at least some of the compartments and to disperse, or begin the dispersion, of the fire fighting agent or agents into the space surrounding the fire suppression device (11).

It can be seen in the figures that many of the compartments are in the form of projectiles (29) that are configured to be ejected from the fire suppression device (11) by the ejection system (27) when the ejection system is activated. The other major compartment is the space (31) surrounding the ejection system (27) and the projectiles (29), that is, the remaining space within the outer housing (25).

The space (31) is filled with fire fighting agent. The fire fighting agent may be any suitable disbursable agent, such as the well-known “dry chemical” type of agent, for example a monoammonium phosphate based product. The projectiles (29) are each filled with fire fighting agent also, for example a combustible agent that uses a potassium nitrate based reaction.

The outer housing (25) includes at least a section in the form of a frangible, or rupturable, outer housing or skin (33).

The combination of the small quantity of ignition media combined with the gaseous release of the potassium mixture will cause a low velocity burst of the rupturable portion of the outer housing. This action will also propel the projectiles from their radially mounted positions around the central ejection system in a random unaimed, unguided fashion, as will be explained in further detail below.

The low pressure burst will also distribute the loose powdered fire fighting agent in a cloud in the immediate vicinity of the device.

The time delayed triggering system (23) is configured to initiate the ejection system (27). The triggering system (23) includes a time delay (35). This allows the fire suppression device (11) to first be triggered and then to be thrown into or toward a fire. The time delay (35) can include a sprung firing pin, a detonating cap and a slow burning fuse or a similar device as commonly used in other devices where the ignition of a flammable product needs to be delayed for a short time, for example two to four seconds.

FIG. 2 shows a twinned triggering system (23). This option is intended to provide redundancy in case of a firing pin or cap failure. The twinned systems (23) will be released simultaneously via the single trigger spoon (17). The twinned systems (23) are depicted one above the other, however it is envisaged that they could be mounted side by side.

The ejection system (27) includes bursting charge. The bursting charge can be a quantity of high burn rate, or highly flammable, material (37) and is configured to propel each of the projectiles (29) from the device (11). For example, the material (37) can be a high burn rate, or highly flammable, medium in the form of a powder or a gel. The medium may be an accelerated rate fire fighting agent, gun powder or a flash powder based product. The material needs to be chosen carefully considering the use of the fire suppression device (11) to ensure compliance with any relevant safety regulations, and to minimise the possibility of harm to equipment or people in the unlikely event of a malfunction.

The ejection system (27) includes a central body, or inner housing (41) that is surrounded by the projectiles (29) in which the ignitable fire fighting agent is held and by the monoammonium phosphate based agent in the space (31) between the projectiles (29).

The inner housing (41) includes holes (43) configured to support and retain the projectiles (29) until the ejection system (27) is activated. The projectiles (29) are held within the holes (43) by an interference fit between the projectiles (29) and the holes (43). Optionally some or all of the projectiles (29) can be held within the holes of the inner housing (41) by a threaded connection between the projectiles (29) and the holes (43), for example a threaded joint with a relatively low joint strength which will be broken by the ejection system (27).

When the fire suppression device (11) is used, the frangible or rupturable skin (33) breaks or ruptures when the ejection system (27) is initiated, and the highly flammable material (37) expands rapidly. This causes the fire fighting agent from the space (31) about the projectiles, and from the projectiles (29), to be released into the surrounding space, i.e. into the fire surrounding the device (11).

The inner ends of each of the projectiles (29) are open to the ejection system. The fire fighting agent in the projectiles (29) is of the type that burns to produce a fire suppressant product. The fire fighting agent in the projectiles (29) is ignited by the explosive charge when the projectiles (29) are propelled from the device (11).

The projectiles (29) are in the form of cylindrical casings which hold a quantity of fire fighting agent, and which are open at one end to, and communicates with, the explosive charge of the ejection system. As noted above, the projectiles are filled with a potassium nitrate based combustible agent. The opening in the projectiles that faces the explosive charge is an orifice that is configured to produce a high velocity flow of fire fighting agent combustion products from the interior of the casing when the casing has been ejected by the ejection system. For example, the orifice can be approximately two to three millimetres in diameter whilst the projectiles (29) have an external diameter of eight to twelve millimetres.

The cylindrical casings can be formed of metal and the orifice is a small aperture with an inherent heat sink capability. This feature minimises the possibility of a “flame out” while the projectiles (29) are in flight, and the rapid exhaust caused by the small aperture orifice will add propulsion to the projectiles (29) and resist ingression of liquid if the projectiles (29) become submerged.

The rupturable outer skin or casing (33) includes a sleeve made of a rubberised product, and it includes lines of weakness configured to allow the outer casing (33) to rupture in a pre-determined manner. Prior to use as a fire suppression device, the rupturable outer casing supports and retains the fire fighting agent and the projectiles (29).

As noted above, the device can be thrown into a fire, and will burst within the fire to disperse fire fighting agent. Some of the fire fighting agent is expelled directly from the space about the projectiles and into the fire, and some is carried by the projectiles a greater distance from the device, and these each continue to discharge fire fighting products for a short time. In this way, the device has an effect over are relatively large area, and can be centred at the heart of a blaze.

FIG. 2 shows the device (11) in four sections A through D. Section A shows the handle (13), the trigger (17) and the triggering system (23). Section B shows the ejection system (27) and the inner housing (41). Section C shows the projectiles (29) and the spaces (31) surrounding the inner housing (41) and the projectiles (29). Section D shows a section of the rupturable skin (33) and the base ring (15).

The device (11) can be mounted in a box for security, or open to a room on a mounting bracket. The bracket could be used to mount the device on a wall or on a ceiling. It is envisaged that the bracket could include a collar or strap or similar fastening system that is configured to fail when exposed to excessive heat, for example the heat from a fire within the room. A device (11) mounted in this way from a ceiling could fall into a relatively central location within the room in the event that the room is ablaze.

The mounting system could also include means to remove the safety pin (21), or to otherwise initiate the triggering system, as the device (11) is removed, or falls from the mounting bracket or box.

The bracket design can include a heat activated release, particularly for the ceiling mounted option. Mounted in this fashion, the safety pin could be removed and the spoon retaining the firing pins would remain in position until a heat sensitive strap releases the device to fall from the bracket by gravity. This feature would allow for a semi-automated initiation with no modification to the main device design.

Similarly a wall mounted bracket design could include a frangible retention strap. The frangible strap could have sufficient strength for use in vehicles, and would force the user to firmly grasp the handle as intended to pull the device from the bracket.

### Variations

To those skilled in the art to which the invention relates, many changes in construction and widely differing embodiments and applications of the invention will suggest themselves without departing from the scope of the invention as defined in the appended claims. The disclosures and the description herein are purely illustrative and are not intended to be in any sense limiting.

It is envisaged that in an alternative configuration, the triggering system could include a mechanism configured to trigger the device when the device comes into contact with another object or a surface, i.e. after it is thrown into a fire and when it hits the ground or another hard surface. Or alternatively, the fire could be used to initiate the triggering system, for example by igniting a fuse.

In the example described above, the bursting charge is in the form of a quantity of high burn rate, or highly flammable material. Optionally the bursting charge could include a compressed material, for example a compressed inert gas. The compressed gas could be in the form of a gas canister or a CO2 cartridge for example. This type of bursting charge would be suitable for fire suppression devices intended for use in more sensitive environments, for example for use in aircraft.

As a further alternative, the bursting charge could include an explosive compound.

As an alternative to the projectiles, some of the compartments can be in the form of housings fixed to the inner housing and configured to release fire fighting agent in the immediate vicinity of the fire suppression device. For example, these compartments could be held by a strong threaded connection. In this case the compartments are retained in the inner housing and are not ejected. Their function is to provide additional fire fighting agent at the resting point of the fire suppression device by venting their contents via the holes left by the ejected projectiles.

### Definitions

Throughout this specification the word “comprise” and variations of that word, such as “comprises” and “comprising”, are not intended to exclude other additives, components, integers or steps.

### ADVANTAGES

Thus it can be seen that at least the preferred form of the invention provides a fire suppression device which can be thrown into a fire, and which is configured to disperse fire fighting agent over a wide area to help suppress or extinguish a fire. This allows even a relatively inexperienced fire fighter, or a by-stander, to get fire fighting agents right into the heart of a blaze, and into places that could not be reached using a conventional fire extinguisher.

The fire suppression device maximises the efficiency of the fire fighting agent of the device, without the user having to spend time close to the fire.

1. A fire suppression device having multiple compartments in which a fire fighting agent or agents are held, and having an ejection system adapted to activate the fire fighting agent held in at least some of the compartments and to disperse the fire fighting agent or agents into the space surrounding the fire suppression device.

2. A fire suppression device as claimed in claim 1, wherein at least some of the compartments are in the form of projectiles that are configured to be ejected from the fire suppression device by the ejection system when the ejection system is activated.

3. A fire suppression device as claimed in claim 1, wherein at least one of the compartments is in the form of a space surrounding the ejection system and defined within, an at least partially frangible, or rupturable, outer housing or skin.

4. A fire suppression device as claimed in claim 3, wherein the frangible, or rupturable, outer housing or skin includes a sleeve made of a rubberised product.

5. A fire suppression device as claimed in claim 3, wherein the frangible, or rupturable, outer housing includes lines of weakness configured to allow the outer housing to rupture or break in a pre-determined manner.

6. A fire suppression device as claimed in claim 1, wherein the ejection system includes an inner housing that is surrounded by the compartments in which an ignitable fire fighting agent is held.

7. A fire suppression device as claimed in claim 6, wherein the inner housing includes holes configured to support and retain the projectiles until the ejection system is activated.

8. A fire suppression device as claimed in claim 7, wherein the projectiles are held within the holes of the inner housing by an interference fit between the projectiles and the holes.

9. A fire suppression device as claimed in claim 1, wherein the ejection system includes a bursting charge.

10. A fire suppression device as claimed in claim 9, wherein the bursting charge includes a flammable compound.

11. A fire suppression device as claimed in claim 9, wherein the bursting charge includes a compressed material.

12. A fire suppression device as claimed in claim 1, wherein the ejection system includes a time delayed triggering system.

13. A fire suppression device as claimed in claim 1, wherein the activation of the fire fighting agent is by ignition.

14. A fire suppression device as claimed in claim 13, wherein the projectiles are in the form of cylindrical casings which hold a quantity of ignitable fire fighting agent, and which are open at one end to the bursting charge of the ejection system and configured so that the ignition of the fire fighting agent in each projectile occurs substantially simultaneously.

15. A fire suppression device as claimed in claim 14, wherein each of the cylindrical casings includes an orifice that is initially in communication with the bursting charge of the ejection system, and each orifice is configured to produce a high velocity flow of fire fighting agent combustion products from the interior of each of the casings when the casings are ejected by the ejection system.

16. A fire suppression device as claimed in claim 3, wherein the space surrounding the projectiles and the ejection system and within the outer housing or skin is filled with a fire fighting agent.

17. A fire suppression device as claimed in claim 16, wherein, the fire fighting agent is a compound or mixture that is activated by ignition.

18. A fire suppression device as claimed in claim 16, wherein the fire fighting agent surrounding the projectiles is a monoammonium phosphate based product.

19. A fire suppression device as claimed in claim 2, wherein the fire fighting agent contained within each of the projectiles is of a type that uses a potassium nitrate based reaction.

20. A fire suppression device as claimed in claim 1, wherein the outer housing includes at least one hard edge configured for use in breaking hard objects.
